(19) United States
(12) Patent Application Publication
(10) Pub. No.: US 2014/0251100 A1
(43) Pub. Date: Sep. 11, 2014

(54) Cutting Method

(71) Applicants: Cornelius Johannes Pretorius, Sixmilebridge (IE); Peter Michael Harden, Limerick (IE); Tom Patrick Howard, Ennis (IE)

(72) Inventors: Cornelius Johannes Pretorius, Sixmilebridge (IE); Peter Michael Harden, Limerick (IE); Tom Patrick Howard, Ennis (IE)

(21) Appl. No.: 14/283,564

(22) Filed: May 21, 2014

Related U.S. Application Data
(63) Continuation of application No. 12/096,962, filed on Sep. 3, 2008, now abandoned.

(30) Foreign Application Priority Data
Dec. 12, 2005 (ZA) 2005/10083

(51) Int. Cl. B26D 1/00; B23D 61/18; B23C 5/16; B27G 13/00; B27G 15/00

(52) U.S. Cl. CPC B26D 1/0006; B27G 13/00; B27G 15/00; B23C 5/16; B23D 61/18; B26D 2001/0053; B26D 2001/002
USPC 83/13; 144/363; 409/131; 144/365

(57) ABSTRACT

A cutting tool component which has an ultra-thin layer of ultra-hard material bonded to a cemented carbide substrate. The ultra-thin layer of ultra-hard material has a thickness of no greater than 0.2 mm. This cutting tool is used to cut workpieces under roughing and/or interrupted cut conditions. Where the workplace is a wood product or wood composite the invention extends to cutting such workpieces in general. The ultra-hard material is preferably PCD or PCBN.

This application is a continuation of U.S. patent application Ser. No. 12/096962 filed Sep. 3, 2008 entitled “Cutting Method” which is a 371 filing of international application PCT/IB2006/003559 filed Dec. 12, 2006 and which claims priority benefits to South African application number 2005/10083 filed Dec. 12, 2005, the disclosures of which are all incorporated herein by reference.

### BACKGROUND OF THE INVENTION

This invention relates to a cutting method and an ultra-hard cutting tool component for use in such a method.

Ultra-hard abrasive cutting elements or tool components utilizing diamond compacts, also known as PCD, and cubic boron nitride compacts, also known as PCBN, are extensively used in drilling, milling, cutting and other such abrasive applications. The element or tool component will generally comprise a layer of PCD or PCBN bonded to a support, generally a cemented carbide support. The PCD or PCBN layer may present a sharp cutting edge or point or a cutting or abrasive surface.

Diamond abrasive compacts comprise a mass of diamond particles containing a substantial amount of direct diamond-to-diamond bonding. Polycrystalline diamond will typically have a second phase containing a diamond catalyst/solvent such as cobalt, nickel, iron or an alloy containing one or more such metals, cBN compacts will generally also contain a bonding phase which is typically a cBN catalyst or contain such a catalyst. Examples of suitable bonding phases are aluminium, alkali metals, cobalt, nickel, tungsten and the like.

Polycrystalline diamond (PCD) cutting elements are widely used for machining a range of metals and alloys as well as highly abrasive wood composite materials. The automotive, aerospace and woodworking industries in particular use PCD to benefit from the higher levels of productivity, precision and consistency it provides. Aluminium alloys, bi-metals, copper alloys, graphite reinforced plastics and metal matrix composites are typical materials machined with PCD in the metalworking industry. Laminated flooring boards, cement boards, chipboard, particle board and plywood are examples of wood products in this class. PCD is also used as inserts for drill bodies in the oil drilling industry.

The failure of a tool due to progressive wear is characterised by the development of wear scars on its operating surfaces. Typical areas on a cutting tool insert where the wear scars develop include the rake face, the flank face and the trailing edge, and the wear features include flank wear, crater wear, DOC notch wear, and trailing edge notch wear.

To numerically describe wear occurring on cutting tool surfaces, a number of parameters are used. The flank wear land is the best known tool wear feature. In many cases the flank wear land has a rather uniform width along the middle portion of the straight part of the major cutting edge. The width of the flank wear and (VB_{B}max) is a suitable tool wear measure and a predetermined value of VB_{B}max is regarded as a good tool life criteria [INTERNATIONAL STANDARD (ISO) 3685, 1993. Tool life testing with single point turning tools]. The cutting forces and temperatures tend to increase as VB_{B}max increases. There is also a greater tendency for vibration to occur and there is a reduction in the quality of the surface finish of the workpiece material. In finishing applications where PCD and PCBN cutting tools are normally used the flank wear criteria is: VB_{B}max=0.2−0.3 mm. In roughing application, where only carbide is normally used, the flank wear criteria is 0.6 mm and higher.

In order for the wear to be limited to the PCD and PCBN layer, current commercially available PCD and PCBN cutting tools all have sintered PCD/PCBN (hard layers) with thicknesses above 0.2 mm. These thick, hard layers, especially in the case of PCD, make them extremely difficult and expensive to process. Typical processes used to fabricate cutting tools are wire electrical discharge machining (w-EDM), electrical discharge grinding (EDG), mechanical grinding, laser cutting, lapping and polishing. Cutting tools comprising PCBN, ceramics, cermets and carbides are normally mechanically ground to the final ISO 1832 specification, while cutting tools comprising PCD are finish produced by EDG or w-EDM. Where PCD elements are mechanically ground, the cost of the grinding operation can be up to 80% of the element's cost. This is because PCD is much harder and therefore more difficult to grind than carbide. It is also not possible to grind PCD on the same grinding machines that are used for grinding PCBN, carbide, cermets or ceramics containing components. PCD requires much stiffer machines and only one corner can be ground at a time as compared to PCBN, ceramic and carbide, where one can grind 4 corners at a time.

The higher processing cost together with the inability to grind PCD on existing carbide grinding machines, has been one of the major obstacles restricting PCD's penetration into traditional carbide applications. End-users generally specify a minimum tool life criteria (generally one shift) together with a certain cycle time, which is dependent on the overall speed of the production line. Since carbide can only be used at low cutting speeds, tooling for carbide normally consist of multiple inserts. The use of multiple inserts allows the feed per tooth or chip load to stay the same, while increasing the necessary production speed. PCD and PCBN, however, can be used at much higher cutting speeds making it possible to either use fewer inserts in the tool body or to achieve a much longer tool life. Since the cost of carbide tools are only about 10% of that of PCD, the tool life in PCD needs to be 10 times longer than that of carbide in order to justify the use of PCD. This has lead to PCD tooling being used only for very severe and abrasive applications as well as high volume applications where carbide tools are unable to meet the minimum tool life criteria.

In addition to this, the lower chip resistance of PCD compared to carbide has restricted its use even further to only finishing applications. In roughing and interrupted applications (high feed rate and depth of cut), where the load on the cutting edge is much higher, PCD can easily fracture causing the tool to fail pre-maturely. Carbide on the other hand wears quicker than PCD, but is more chip resistant. Unlike in finishing operations, dimensional tolerance is not so critical in roughing operation (VB_{B}max>0.6 mm) which means that tool wear is not that critical. However, chip resistance is important in roughing applications and can cause the tool to fail prematurely. Also, in less severe applications, like MDF, low SiAl-alloys, chipboard etc, wear is generally not an issue and carbide is preferred due to economic reasons.

For PCD and PCBN to be considered for typical carbide applications, it has to be easier and cheaper to process and have higher chip resistance, while still outperforming carbide in terms of wear resistance.

Another disadvantage of currently available PCD cutting tools is that they are not designed to machine ferrous materials. When machining cast irons for example, the cutting forces and thus the cutting temperature at the cutting edge are much higher compared to non-ferrous machining. Since PCD starts to graphitise around 700° C., it limits its use to lower cutting speeds when machining ferrous materials, rendering it uneconomical in certain applications compared to carbide tools.

U.S. Pat. No. 3,745,623 describes a method of making a tool component comprising a layer of PCD bonded to a cemented carbide substrate. The thickness of the PCD layer can range from 0.75 mm to 0.012 mm. The tool component is intended to provide a less expensive form of diamond cutting tool to be used in the machining of metals, plastics, graphite composite and ceramics where more expensive synthetic, or natural diamond is normally used.

U.S. Pat. No. 5,697994 describes a cutting tool for woodworking applications comprising a layer of PCD on a cemented carbide substrate. The PCD is generally provided with a corrosion resistant or oxidation resistant adjuvant alloying material in the bonding phase. An example is provided wherein the PCD layer is 0.3 mm in thickness.

EP 1 053 984 describes diamond sintered compact cutting tool comprising a diamond sintered compact bonded to a cemented carbide substrate in which the thickness of the diamond layer satisfies a particular relationship to the carbide substrate. Diamond compact layers varying in thickness from 0.05 mm to 0.45 mm are disclosed. Generally, the carbide substrates are thin, particularly when thin diamond layers are used because the substrate thickness needs to be matched to that of the PCD

### SUMMARY OF THE INVENTION

According to the present invention, a method of cutting a workpiece includes the steps of providing a cutting tool component which comprises a body comprising a cemented carbide substrate and having at least one working surface, the at least one working surface presenting a cutting edge or area for the body, characterized in that the at least one working surface comprises ultra hard abrasive material adjacent the cutting edge or area and extending to a depth of no greater than 0.2 mm from the at least one working surface and wherein the substrate has a thickness of 1.0 to 40 mm, and effecting a cut in the workpiece under roughing and/or interrupted machining conditions.

In one preferred embodiment of the invention, the cutting tool component body comprises a cemented carbide substrate and an ultra-thin layer of ultra-hard material bonded to a major surface of the substrate, the ultra-thin layer of ultra-hard material having a thickness of no greater than 0.2 mm and the substrate has a thickness between 1.0 to 40 mm, the ultra-thin layer defining a working surface.

The invention uses a cutting tool component with a ultra-thin, i.e. no greater than 0.2 mm in thickness or depth, layer of ultra-hard material to provide a cutting edge. This layer of ultra-hard material is bonded to a cemented carbide substrate. The tool component is used in cutting workpieces under roughing or interrupted machining conditions. These are severe conditions involving significant loading on the cutting edge and are well known in the art. It is common for cheaper materials such as cemented carbide tool components to be used in such cutting applications. Ultra-hard material tool components are generally used only in finishing applications where a fine finish is required and the cost of using ultra-hard material can be justified. The ultra-thin layer of ultra-hard material allows the tool component of this invention to be manufactured at a cost competitive with cemented carbide tool components and offers other advantages, such as a self-sharpening ability, as is described hereinafter.

Generally, the workpieces will be metal such as ferrous metals or alloys or hard metals or alloys such as silicon/aluminium alloys, ceramics, composites, wood products or wood composites.

The invention extends to cutting a wood product or wood composite, particularly milling, sawing or turning using a tool component as described above. The cutting action can be continuous, e.g. turning, or interrupted, e.g. milling or sawing.

In an alternative embodiment of the tool component, one or more intermediate layers of a material softer than the ultra-hard material is/are located between the cemented carbide substrate and the ultra-hard material. The intermediate layer or layers are preferably based on a ceramic or metal or ultra-hard material that is softer than the ultra-hard material.

An important feature of the invention is that the cutting is performed by both the PCD and the substrate. Thus, the properties of the substrate can be manipulated and tailored to best suit the workpiece and cutting conditions for a particular application.

In another alternative embodiment of the cutting tool component, the body comprises a cemented carbide substrate having a working surface presenting a cutting edge or area for the tool component and having a plurality of grooves or recesses extending into the substrate from the working surface, and a plurality of strips or pieces of ultra-hard material located in the respective grooves or recesses, the arrangement being such that the ultra-hard material extends to a depth of no greater than 0.2 mm from the working surface and forms a part of the cutting edge or area of the tool component.

The strips or pieces may all be made of an ultra-hard material having the same or essentially the same properties. Alternatively, the property of the ultra-hard material of some of the pieces or strips may differ from that of other pieces or strips.

The thickness of the ultra-hard layer or inserts is preferably from 0.001 to 0.15 mm.

The thickness of the substrate is from 1.0 mm to 40 mm

The ultra-hard material is preferably PCD or PCBN, optionally containing a second phase comprising a metal or metal compound selected from the group comprising aluminium, cobalt, iron, nickel, platinum, titanium, chromium, tantalum, copper, tungsten or an alloy or mixture thereof.

### BRIEF DESCRIPTION OF THE DRAWINGS

The invention will now be described in more detail, by way of example only, with reference to the accompanying drawings in which:

FIG. 1 is a partial perspective view of a first embodiment of a cutting tool component of the invention;

FIG. 2 is a partial perspective view of a second embodiment of a cutting tool component of the invention;

FIG. 3 is a partial perspective view of a third embodiment of a cutting tool component of the invention;

FIG. 4 is a schematic side view of a cutting tool component of the invention in use, illustrating the “self-sharpening” effect thereof;

FIG. 5 is a graph illustrating the effect of hard layer thickness on wear of a cutting tool component;

FIG. 6 is a graph comparing the wear progression of two cutting tool components of the invention with two prior art cutting tool components;

FIG. 7 is a graph comparing the radial forces of two cutting tool components of the invention with two prior art cutting tool components during a cutting test on a 18% SiAl-alloy;

FIG. 8 is a graph comparing the wear progression of two cutting tool components of the invention with two prior art cutting tool components during a roughing test on a 6% SiAl-alloy;

FIG. 9 is a graph illustrating grinding times of various cutting tool components of the invention on an Agathon insert grinder;

FIG. 10 is a graph comparing chip resistance results of two cutting tool components of the invention and a prior art cutting tool component in a cutting test on a 18% SiAl-alloy.

FIG. 11 shows a graph which depicts the survival probabilities of different materials at different feed rates.

FIG. 12 is a graph showing chip size under light interrupted machining conditions for two PCBN cutting tools.

FIG. 13 is a box plot illustrating fracture resistance for PCBN tool cutting tools.

### DESCRIPTION OF PREFERRED EMBODIMENTS

The object of the present invention is to provide an engineered PCD and/or PCBN cutting tool component with properties, between cemented carbide and PCD as well as between cemented carbide and PCBN. This cutting tool component is used in cutting applications which involves significant loading on the cutting edge as is to be found roughing and interrupted machining applications. In roughing operations a major objective is to achieve high substrate, typically metal, removal rates and toughness is the critical tool material requirement. In finishing operations the major objective is a high quality workpiece surface finishing and predictability is the critical tool material requirement.

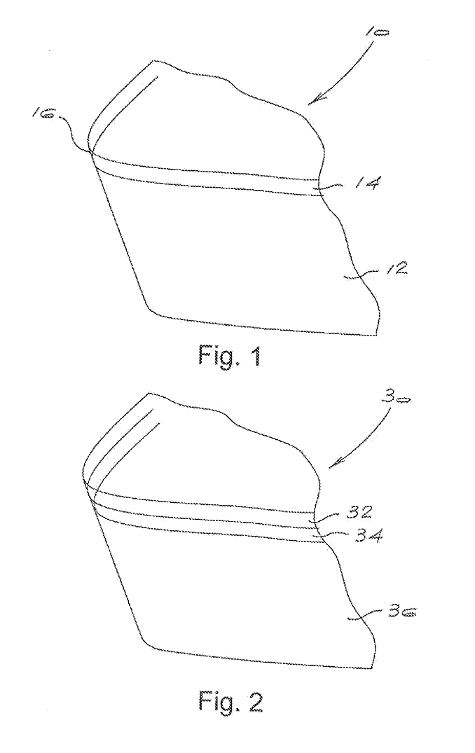

An embodiment of a cutting tool component will now be described with reference to FIG. 1. Referring to this Figure, a cutting tool component 10 comprises a cemented carbide substrate 12 with an ultra-thin layer 14 of ultra-hard material, which has a thickness of no greater than, generally less than 0.2 mm, preferably between 0.001-0.15 mm and wherein the substrate has a thickness from 1.0-40 mm. Such a cutting tool component is, produced by high temperature high pressure synthesis. The thickness of the ultra-thin hard layer 14 at the cutting edge 16 is the critical parameter determining the properties of the material and allows for cutting with both the top hard layer 14 (PCD or PCBN) and the carbide substrate 12. Wear resistance, chip resistance, cutting forces, grindability, EDM ability and thermal stability are all properties affected by the thickness of the hard layer. Various methods for producing PCD and PCBN cutting tools with cemented carbide substrates exist and are well known in the industry.

The ultra-thin hard layer together with the softer substrate results in a “self-sharpening” behaviour during cutting, which in turn reduces the forces and temperatures at the cutting edge. The hard layer can be described as an integrally-bonded structure that is composed of a mass of polycrystalline abrasive particles, such as diamond or cubic boron nitride, and a second phase, which is usually a metal such as cobalt, iron, nickel, platinum, titanium, chromium, tantalum, copper or an alloy or mixture thereof, as described in U.S. Pat. No. 4,063,909 and U.S. Pat. No. 4,601,423. The thickness of the hard layer preferably varies between 0.001-0.15 mm, depending on the required properties for specific applications.

Referring to the tool component 30 of FIG. 2, the ultra-thin hard layer 32 can also be bonded to an intermediate layer 34 of metal or ceramic, which in turn is bonded to the cemented carbide substrate 36.

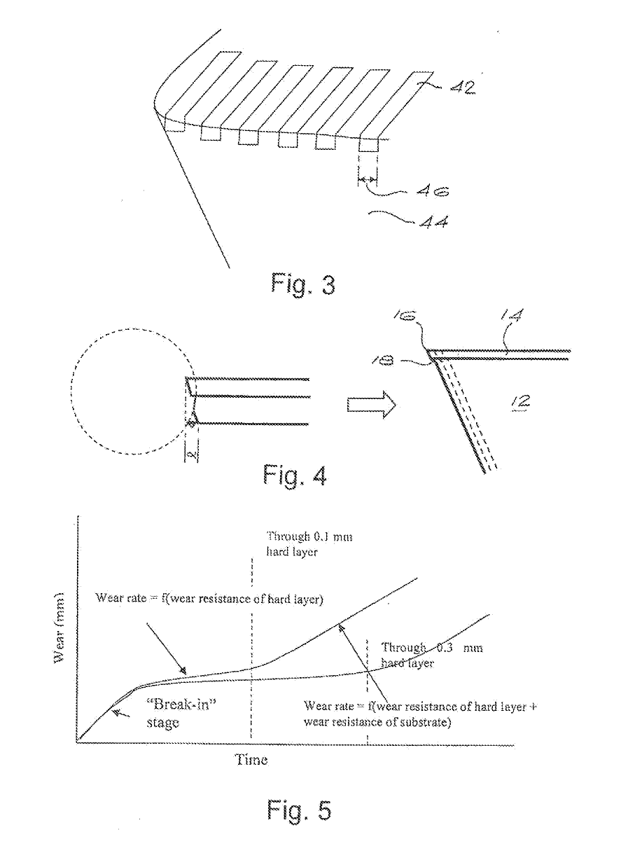

Alternatively, referring to the tool component as illustrated in FIG. 3, the ultra-thin hard layer may also be in the form of strips 42 (vertical layers) across the cutting tool alternating with the substrate material 44, where the width 46 of the strips is between 10 and 50 microns. Other arrangements where recessed pieces of ultra-hard material are located in the substrate material are also envisaged.

The substrate material can be selected from tungsten carbides, ultra-fine grain tungsten carbides, titanium carbides, tantalum carbides and niobium carbides and has a thickness between 1.0 to 40 mm. Methods for producing cemented carbides are well known in the industry. Because cutting is done with both the ultra-hard material and the carbide, the selection of the substrate is another variable which can be changed in order to alter the properties of the cutting element to suit different applications.

In some applications, it may be preferable to provide a substrate having a profiled or shaped surface, which results in an interface with a complimentary shape or profile.

From a processability perspective an important feature of the invention is the ultra-thin hard layer which will reduce the processing cost of PCD and PCBN cutting tools.

In terms of performance the critical feature of the invention is to adjust the hard layer thickness so that the desired properties can be achieved and also to ensure that a ‘self-sharpening” effect takes place during cutting. This could mean adding a softer intermediate layer just below the PCBN or PCD. This means that when the wear progresses through the hard layer at some stage during the cutting process, the cutting will be done by both the hard layer and the substrate and/or the intermediate layer. Conventional tools all have a hard layer thickness above 0.2 mm, and hence the substrate never comes in contact with the workpiece (since tool life criteria is VB_{B}max=0.2-0.3 mm) and the properties and behaviour of the tool is that of the hard layer only.

As illustrated in FIG. 4, as long as cutting is done by the hard layer 14, the wear rate will be that of the hard layer. As soon as the wear extends into the carbide substrate 12 and the cutting is done by both the hard layer and the carbide, the wear rate will increase to include both that of the substrate and of the hard layer. Thus, the thicker the hard layer, the longer the wear rate is controlled by the wear resistance of the hard layer and the longer the tool life, as illustrated graphically in FIG. 5. Having an ultra-thin hard layer where the cutting is done by both the hard layer and the carbide gives a wear resistance between that of carbide and the hard layer. By varying the thickness of the hard layer (between 0.001-0.15 mm) it allows one to change the properties and the tool life of the material to what is required for a specific application. This allows one to provide signature products for specific applications. The thinner the hard layer, the closer the cutting tool properties will be to that of the substrate. However, due to the “self-sharpening” effect of the engineered cutting tool, the cutting process and wear rate are dominated by the hard layer.

A major benefit of cutting with both the ultra-thin hard layer 14 and the substrate 12 is the “self-sharpening” effect it has on the tool. As illustrated in FIG. 4, it can be seen that because the material of the substrate 12 is much softer than the top hard layer 14, it wears away quicker than the hard layer 14, forming a “lip” 18 between the hard layer and the bottom layer at the edge 16. This allows the tool to cut predominantly with the top hard layer 14, minimising the contact area with the workpiece which ultimately results in lower forces and temperatures at the cutting edge 16. It also means that when the tool wears it keeps a clearance angle (α) allowing it to cut more efficiently. This wear behaviour is ideal for roughing applications and wood composite machining, especially in saw blade applications, where dimensional tolerances are not so critical. It is also beneficial in oil drilling applications where a sharp cutter results in a lower “weight on bit” and higher penetration rates. It will also be beneficial in the machining of ferrous materials with PCD where forces should be kept to a minimum to prevent graphitisation. Ultra-thin diamond layers can also be used for finish machining of softer materials, like copper where the wear never extends into the carbide.

Another benefit of ultra-thin hard layers is the improved chip resistance it gives to the tool. Thicker layers have higher residual stresses and are more susceptible to chipping and fracture. Also, if chipping does occur, the carbide substrate will arrest the crack and stop it from getting bigger than the thickness of the top hard layer. A thin PCD layer will also possess higher percentages of cobalt due to the back in-filtration process from the substrate during synthesis increasing its fracture toughness.

Effect on Processability

All processing (EDM, EDG, grinding) is easier and faster as the top hard layer becomes thinner. Having ultra-thin hard layers will shorten processing times and allow materials like PCD to be ground on conventional carbide grinding equipment. This opens the door for new applications for PCD in woodworking and metalworking. In conventional PCD cutting tools 80% of the insert cost can be attributed to grinding, while with the engineered material of the invention this cost is reduced to about 5-10% of the total cost making the engineered product a much more feasible cutting tool.

As explained earlier conventional PCD and PCBN compacts are manufactured with diamond layer thicknesses >0.2 mm in order for the cutting to be done by the hard layer only. However, during the synthesis of such thick layers, the compact often bows because of the thermal expansion differences between that of PCD or PCBN and the carbide substrate. This results in additional processing (mechanical grinding, EDG or lapping) to get the compact back to flatness. With ultra-thin hard layers, bending of the disc is minimised and additional processing is not required. This allows for the production of near-net shape PCD or PCBN compacts.

The invention will now further be discussed, by way of example only, with reference to the following non-limiting examples.

### EXAMPLE 1

### Finishing of 18% SiAl

The abrasion resistance of respective 0.2 mm (0.2 mm PCD) and 0.1 mm (0.1 mm PCD) ultra-thin PCD engineered cutting tools was evaluated in turning an 18% SiAl workpiece and compared to a 0.5 mm PCD layered tool (0.5 mm PCD) as well as a commercially available carbide grade (HM10(HW)) recommended for Al turning. This is a highly abrasive workpiece and can usually only be machined with diamond tools. Test conditions were chosen as to simulate a finishing operation and are as follows:
Cutting Speed: 500 m/min
Feed rate: 0.1 mm/rev
Depth of cut: 0.25 mm.
PCD grade: CTB010

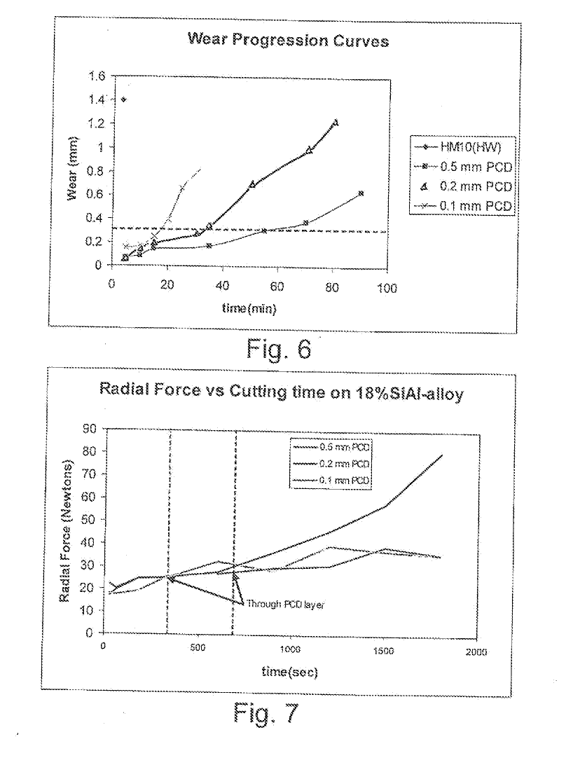

From FIG. 6, it is evident that the carbide grade (HM10(HW)) is not suitable for machining 18% SiAl-alloys. As expected the 0.5 mm thick PCD has the lowest wear rate followed by the 0.2 mm thick variant and then the 0.1 mm thick variant. In the 0.5 mm thick PCD cutting tool, cutting is performed with the PCD layer only, while in the 0.2 mm variant and the 0.1 mm variant both the PCD layer and the carbide substrate comes in contact with the workpiece. In the 0.2 mm variant, the contact area (wear scar) extends into the carbide at around 35 minutes and the wear rate starts to increase. Up to 35 minutes the wear rate is that of the PCD layer only. In the 0.1 mm variant the wear reaches the carbide at around 5 minutes. This means that for finishing applications where tolerances and thus wear are critical, the required wear rate can be engineered into the cutting tool by varying the thickness of the PCD hard layer. The dotted line represents the end-off life criteria for a finishing operation.

Since the carbide is much softer than the PCD it wears away almost instantaneously upon contact with the workpiece, leaving predominantly the PCD layer to do the cutting. This results in a “shelf-sharpening effect”, as explained earlier. In the case of the carbide tool (HM10(HW)), the whole depth of cut has been worn away after only 3 minutes and no further cutting could be done.

FIG. 7 shows a graph comparing the radial force of the 0.5 mm, 0.2 mm and 0.1 mm thick PCD layer. It is evident that the force for the 0.5 mm thick PCD layer keeps increasing as the wear scar becomes bigger. However, because of the “self-sharpening” effect, the forces for the 0.2 mm and 0.1 mm thick PCD variants are much lower. This suggests that these tools will be ideal in roughing application as well as applications where tolerances are not that critical. It also means that because of the lower forces these tools would be able to machine at higher cutting speeds than the 0.5 mm thick conventional PCD.

### EXAMPLE 2

### Roughing of 6% SiAl

To evaluate the roughing ability of the engineered tools, a turning test was performed on a 6% SiAl alloy. The machining conditions were as follows:
Cutting Speed: 800 m/min
Feedrate: 0.5 mm/rev
Depth of cut: 0.5 mm.
PCD Grade: CTB010

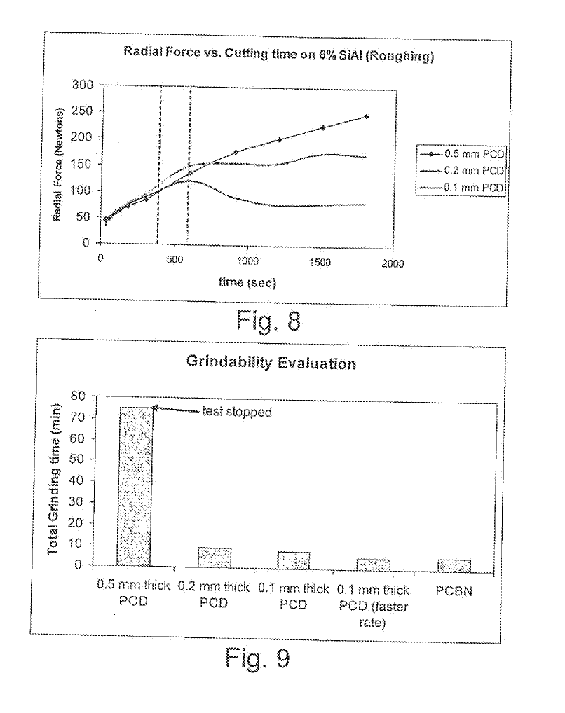

In a roughing application, workpiece tolerances and thus cutting tool wear is not so critical as in finishing operations, but rather chip resistance and cutting force (vibration). FIG. 8 shows a graph comparing the radial forces of the different variants. As in the finishing example, the graph demonstrates that as soon as the wear for the 0.2 mm PCD and 0.1 mm PCD variant extends into the carbide (as reflected by the respective dotted lines) the radial force does not increase anymore. This suggests that for roughing applications thinner PCD (<0.1 mm) thickness materials should cut more efficiently. Again, different PCD cutting tools can be engineered to suit specific applications by varying the thickness of the ultra-thin hard layer at the cutting edge.

### EXAMPLE 3

### Mechanical Grindability

In order to demonstrate the ability to grind ultra-thin PCD layer thickness materials on existing carbide grinders, cutting tools having, respectively, 0.1 mm PCD and 0.2 mm PCD layers, were compared to a 0.5 mm thick PCD cutting tool. The tools were all ground on an Agathon 250 insert grinder from 10.15×10.15 squares to SPMN 090108F at the following conditions:

| | | | 0.1 mm |
|---|---|---|---|
| | 0.2 mm | 0.1 mm | faster rate |
| Wheel speed (m/s) | 21 | 21 | 21 |
| Infeed (mm/sec) | 10 | 30 | 50 |
| Turns per min | 3 | 8 | 10 |

It was not feasible to machine the 0.5 mm thick PCD layer cutting tool on this grinder. After 75 minutes of grinding, the test was stopped. FIG. 9 clearly demonstrates that it is feasible to grind ultra-thin layer PCD cutting tools on existing carbide/PCBN insert grinders. The 0.1 mm thick PCD can be ground at faster rates than PCBN.

### EXAMPLE 4

### Chip Resistance on 18% SiAl

The chip resistance was evaluated by doing edge-milling tests on an 18% SiAl-alloy. In order to promote the formation of chips, a large relief angle was used on the tools. The test conditions were as followed:
cutting speed: 500 m/min
feed per tooth: 0.5 mm
the depth of cut: 2 mm
the relief angle: 18 deg
the width of cut: 15 mm.
PCD Grade: CTB010

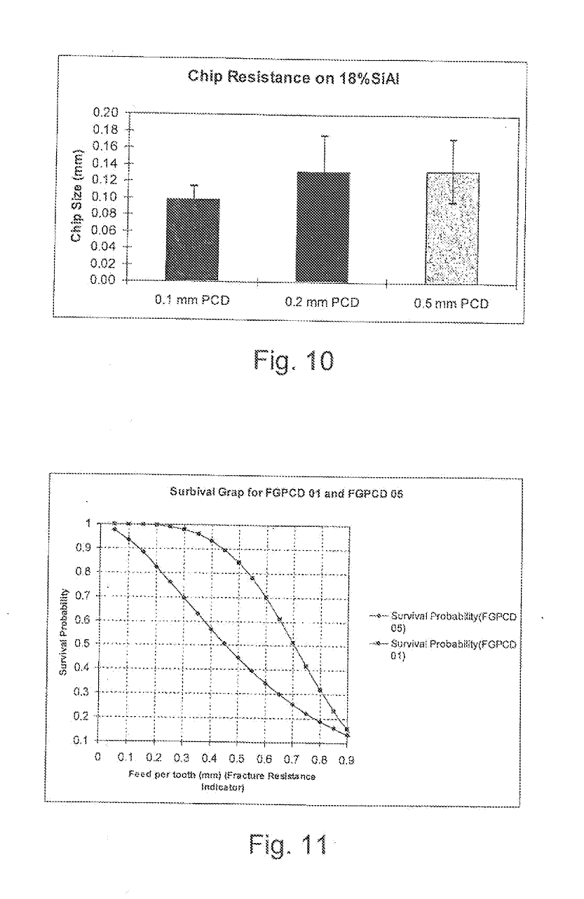

FIG. 10 shows the average chip size of each variant together with the 95% confidence interval for 8 tests. It is clear that the average chip size and scatter in chip size is the smallest for the 0.1 mm ultra thin PCD tool (0.1 mm PCD). Since the chips were all smaller than 200 microns no significant difference was observed between the 0.5 mm PCD (0.5 mm PCD) and the 0.2 mm layer PCD (0.2 mm PCD).

### EXAMPLE 5

### Catastrophic Fracture Resistance Machining Compact Graphite Cast Iron (CGI)

Since catastrophic fracture has a stochastic nature with data generally following a non-normal distribution, Weibull statistics was used to assess the fracture resistance. With Weibull Analysis, a characteristic fracture resistance (α) as well as a shape parameter (β) can be calculated. In this particular test, the characteristic fracture resistance, called a, represents the feed per tooth at which 63.2% of the product will fail. These two parameters (α and β) are then used to calculate the reliability of the two products using the following equation:

$$R = {e}^{- {[ \frac{x}{α} ]}^{β}}$$

Where x is feed per tooth at which failure occurs.

An interrupted milling operation was performed whereby the conditions and workpiece were chosen as to minimise any wear events and in return promote fracture. The feed per tooth was increased from 0.1 to 0.2 to 0.3 etc until catastrophic failure of the nose was observed. The feed per tooth represent the load on the cutting edge and is therefore a suitable fracture resistance indicator. The test conditions that were used are as follow:
Workpiece material: GJC 400 (>95% Pearlite, 10% nodularity)
Cutting Speed: 200 m/min
Feed per tooth: varied
DOC: 1 mm
WOC: ½ the block
Relief angle: 18 deg
Rake angle: 0 deg

FIG. 11 shows a survival graph which depicts the survival probabilities of each material at the different feed rates. It can be seen that FGPCD 01 (fine grain PCD) has a much higher survival probability at the different feed rates than FGPCD 05. The Weibull calculated characteristic fracture resistance for the two materials are as follow:
FGPCD 05=0.577
FGPCD 01=0.774

This suggests that the 0.1 mm layer has a 34% higher fracture resistance than the 0.5 mm layer. From this it is evident that the fracture resistance can be engineered by using different thickness PCD layers.

### EXAMPLE 6

### AISI4340 ‘Drilled’ Light Interrupted Machining Test

The test is believed to be very representative of hard machining. Two PCBN cutting tool components of the type described above were used in the test. The one had an ultra-thin PCBN layer 0.1 mm in thickness and the other a PCBN layer of 0.5 mm thickness. The maximum chip size was recorded. The test conditions were as follow:

| | | Depth of | Cutting | |
|---|---|---|---|---|
| | Feed, f | cut, aₚ | Speed, v_{c} | Insert |
| Test | (mm) | (mm) | (m/min) | Geometry |
| (AISI) | 0.15 | 0.2 | 150 | SNMN090308 |
| 4340 | | | | S0220 |
| Drilled | | | | |
| Face- | | | | |
| Turning | | | | |

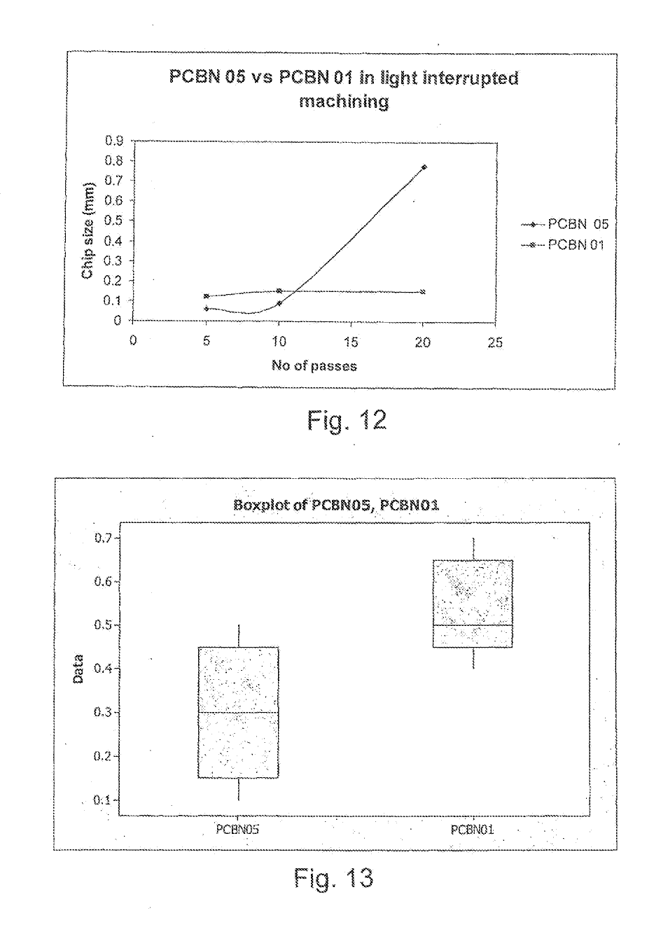

From the graph of FIG. 12 it can be seen that the ultra-thin PCBN exhibits less fracture than the thicker 0.5 mm layer. As was the case with PCD the actual chip on the edge gets “arrested” once the fracture path reaches the carbide. From there onwards wear is the critical feature and not fracture.

### EXAMPLE 7

### Roughing Example: Catastrophic Fracture Resistance Machining Compact Graphite Cast Iron (CGI)

An interrupted milling operation was performed using the same two PCBN cutting tool components of Example 6 whereby the conditions and workpiece were chosen as to minimise any wear events and in return promote fracture. The feed per tooth was increased from 0.1 to 0.2 to 0.3 etc until catastrophic failure of the nose was observed. The feed per tooth represent the load on the cutting edge and is therefore a suitable fracture resistance indicator. The test conditions that were used are as follow:
Workpiece material; GJV 400 (>95% Pearlite, 10% nodularity)
Cutting Speed: 300 m/min
Feed per tooth: varied
DOC: 1 mm
WOC: ½ the block
Relief angle: 18 deg
Rake angle: 0 deg

From the Box-plot of FIG. 13 it appears that the 01 layer has a higher fracture resistance than the 05 layer. Since this data is not normally distributed, a Kruskal-Wallis Statistical test was performed in order to evaluate whether this improvement is significant. Since the P-value is smaller than 0.05 it can be concluded that the thin layer is significantly more fracture resistant than the 0.5 mm layer

Kruskal-Wallis Test: Fz Failure Versus Tool Material

Kruskal-Wallis Test on Fz Failure

| Tool | | | Ave | |
|---|---|---|---|---|
| Material | N | Median | Rank | Z |
| PCBN01 | 5 | 0.5000 | 7.5 | 2.09 |
| PCBN05 | 5 | 0.3000 | 3.5 | −2.09 |
| Overall | 10 | | 5.5 | |

H = 4.36 DF = 1 P = 0.037
H = 4.50 DF = 1 P = 0.034 (adjusted for ties)

1. A method of cutting a workpiece including the steps of providing a tool component which comprises a body comprising a cemented carbide substrate and having at least one working surface, the at least one working surface presenting a cutting edge or area for the body, characterized in that the at least one working surface comprises ultra hard abrasive material adjacent the cutting edge or area and extending to a depth of no greater than 0.2 mm from the at least one working surface and wherein the substrate has a thickness of 1.0 to 40 mm, and effecting a cut in the workpiece under roughing conditions, wherein the ultra hard abrasive material is PCD or PCBN and the cut being effected in the workplace first by the PCD or PCBN material cutting edge or area and thereafter by both the PCD or PCBN material cutting edge or area and the substrate.

2. A method according to claim 1 wherein the workplace is a metal, composite or ceramic workplace.

3. A method according to claim 1 wherein the workpiece is a wood or wood composite workplace.

4. A method according to claim 3 wherein the cut is effected by milling or sawing.

5. A method of cutting a wood product or wood composite including the steps of providing a tool component which comprises a body comprising a cemented carbide substrate and having at least one working surface, the at least one working surface presenting a cutting edge or area for the body, wherein at least one working surface comprises ultra hard abrasive material adjacent the cutting edge or area and extending to a depth of no greater than 0.2 mm from the at least one working surface and wherein the substrate has a thickness of 1.0 to 40 mm, and effecting a cut in the workpiece, wherein the ultra had abrasive material is PCD or PCBN and the cut being effected in the workpiece first by the PCD or PCBN material cutting edge or area and thereafter by both the PCD or PCBN material cutting edge or area and the substrate.

6. A method according to claim 5 wherein the cut is effected by milling, turning or sawing.

7. A method according to claim 1 wherein the cutting edge or area extends to a depth of 0.001 to 0.15 mm from the at least one working surface.

8. A method according to claim 1 wherein the cutting tool component body comprises a cemented carbide substrate and an ultra-thin layer of ultra-hard material bonded to a major surface of the substrate, the ultra-thin layer having a thickness of no greater than 0.2 mm and the working surface presenting a cutting edge or area for the cutting tool component.

9. A Method according to claim 8 wherein the ultra-thin layer has a thickness of 0.001 to 0.15 mm.

10. A method according to claim 1 wherein one or more intermediate layers are located between the substrate and the ultra-hard material, the intermediate layer or layers being of a material which is softer than the ultra-hard material.

11. A method according to claim 10 wherein the intermediate layer or layers are made of a ceramic, metal or an ultra-hard material.

12. A method according to claim 1 wherein the cutting tool body comprises a cemented carbide substrate having a working surface presenting a cutting edge or area for the tool component and having a plurality of grooves or recesses extending into the substrate from the working surface, and a plurality of strips or pieces of ultra-hard material located in the grooves or recesses, the arrangement being such that the ultra-hard material extends to a depth of no greater than 0.2 mm from the working surface and forms a part of the cutting edge or area of the tool component.

13. A method according to claim 12 wherein the strips or pieces are all made of an ultra-hard material of the same or essentially the same property.

14. A method according to claim 12 wherein the ultra-hard material of some of the strips or pieces differ from that of other strips or pieces.

15. A method according to claim 5 wherein the cutting edge or area extends to a depth or 0.001 to 0.15 mm from the at least one working surface.

16. A method according to claim 5 wherein the cutting tool component body comprises a cemented carbide substrate and an ultra-thin layer of ultra-hard material bonded to a major surface of the substrate, the ultra-thin layer having a thickness of no greater than 0.2 mm and the working surface presenting a cutting edge or area for the cutting tool component.

17. A method according to claim 5 wherein one or more intermediate layers are located between the substrate and the ultra-hard material, the intermediate layer or layers being of a material which is softer than the ultra-hard material.

18. A method according to claim 5 wherein the cutting tool body comprises a cemented carbide substrate having a working surface presenting a cutting edge or area for the tool component and having a plurality of grooves or recesses extending into the substrate from the working surface, and a plurality of strips or pieces of ultra-hard material located in the grooves or recesses, the arrangement being such that the ultra-hard material extends to a depth of no greater than 0.2 mm from the working surface and forms a part of the cutting edge or area of the tool component.

19. A method according to claim 1 wherein the cutting tool component body comprises a cemented carbide substrate selected from the group consisting of tungsten carbides, ultra-fine grain tungsten carbides, titanium carbides, tantalum carbides, and niobium carbides.
